(19) United States
(12) Patent Application Publication
(10) Pub. No.: US 2010/0117843 A1
(43) Pub. Date: May 13, 2010

(54) HEAT PUMP TYPE HOT WATER SUPPLY APPARATUS

(75) Inventor: Kouji Kobayashi, Gunma (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Gunma (JP)

(21) Appl. No.: 12/513,108

(22) PCT Filed: Jun. 6, 2008
(86) PCT No.: PCT/JP2008/060446

§ 371 Date: Apr. 30, 2009

(30) Foreign Application Priority Data
Jun. 15, 2007 (JP) 2007-158902

(51) Int. Cl. G08B 21/00; F25B 13/00; F24H 9/02

(52) U.S. Cl. 340/622; 62/324.1; 165/47; 340/618

(57) ABSTRACT

This heat pump type hot water supply apparatus has a remaining hot water display (41) which displays remaining hot water in a hot water storage tank (22) by a plurality of scales (41a-41e) step by step, and a display controller (30) which changes the remaining hot water display (41) according to the amount of remaining hot water in the hot water storage tank (22). A change amount of hot water which changes a level lighting 3 scales (41c-41e) of the remaining hot water display (41) to the next level thereof by the display controller (30) is larger than a change amount of hot water which changes a level lighting 4 scales (41b-41e) of the remaining hot water display (41) to the next level thereof by the display controller (30).

### BACKGROUND OF THE INVENTION

(i) Field of the Invention

The present invention relates to, for example, a heat pump type hot water supply apparatus which displays an amount of remaining hot water in a hot water storage tank by a plurality of levels.

(ii) Description of the Related Art

Generally, as a hot water supply apparatus which displays the amount of remaining hot water in the hot water storage tank, a hot water storage type water heater is known to comprise a remaining calorific value detecting means for detecting a remaining calorific value Q in a hot water storage tank, a remaining hot water amount calculating means for converting the remaining calorific value Q to a remaining hot water amount q at a predetermined converting temperature Tc, a remaining hot water supply time calculating means for converting the remaining hot water amount q to a remaining hot water supply time t at a predetermined conversion flow rate fc, and a display part which displays the remaining hot water supply time t. The hot water storage type water heater clearly displays remaining hot water in the hot water storage tank.

Patent Document 1: Japanese Patent Publication 2004-144327

### DISCLOSURE OF THE INVENTION

### Problems to be Solved by the Invention

On the other hand, with regard to the heat pump type hot water supply apparatus which displays remaining hot water in a hot water storage tank by a plurality of levels, for example, when remaining hot water is displayed by 5 levels, remaining hot water can be displayed by level 2 out of 5 levels even though hot water still remains half of the capacity of the storage tank. In this case, the amount of remaining hot water looks less than the actual amount and users become anxious about shortage of hot water.

An object of the present invention is to provide a heat pump type hot water supply apparatus which is capable of preventing users from being unnecessarily anxious about shortage of hot water.

### Means for Solving the Problems

In order to achieve the above object, the present invention, a heat pump type hot water supply apparatus, is provided with a remaining hot water display for displaying the amount of remaining hot water in a hot water storage tank by a plurality of levels, a display control means for changing the remaining hot water display according to the amount of remaining hot water in the hot water storage tank. A change amount of hot water which changes the remaining hot water display from a predetermined level to the next level thereof by the display control means is larger than a change amount of hot water which changes the remaining hot water display from the other levels to the next level thereof by the display control means.

In this heat pump type hot water supply apparatus, the change amount of hot water which changes the remaining hot water display from the predetermined level to the next level thereof is larger than the change amount of hot water which changes the remaining hot water display from the other levels to the next level thereof. Thus, the remaining hot water display does not change from the predetermined level to the next level thereof, when the amount of hot water which changes the remaining hot water display from the other levels to the next level thereof is supplied from the hot water storage tank to the outside.

### Advantages of the Invention

In this heat pump type hot water supply apparatus, the remaining hot water display does not change from the predetermined level to the next level thereof when the amount of hot water which changes the remaining hot water display from the other level to the next level thereof is supplied from the hot water storage tank to the outside. Hence, it is possible to make the amount of remaining hot water in the hot water storage tank at the predetermined level look larger compared to the other levels. Also, by appropriately setting up an amount of hot water which changes from the predetermined level to the next level thereof, it becomes possible to display the amount of remaining hot water which is not so different from the actual amount of hot water in the hot water storage tank. Therefore, it is possible to prevent users from being unnecessarily anxious about shortage of hot water.

The above and other objects, features, and advantages of the present invention will become more apparent from the following description and the accompanying drawings.

### BRIEF DESCRIPTION OF THE DRAWINGS

FIG. 1 is an outline composition view of a heat pump type hot water supply apparatus;

FIG. 2 is a block diagram showing a control system composition of the heat pump type hot water supply apparatus shown in FIG. 1;

FIG. 3 is an external front view of a remote controller shown in FIG. 2;

FIG. 4, is a diagram showing a relationship between remaining hot water in a hot water storage tank and a remaining hot water display; and

FIG. 5 is a diagram showing a relationship between remaining hot water in the hot water storage tank and the remaining hot water display.

### DESCRIPTION OF THE SYMBOLS

22 . . . hot water storage tank, 29a-29f . . . stored hot water thermometers, 30 . . . display controller, 40 . . . remote controller, 41 . . . remaining hot water display, 41a-41e . . . scales.

### DESCRIPTION OF THE PREFERRED EMBODIMENTS

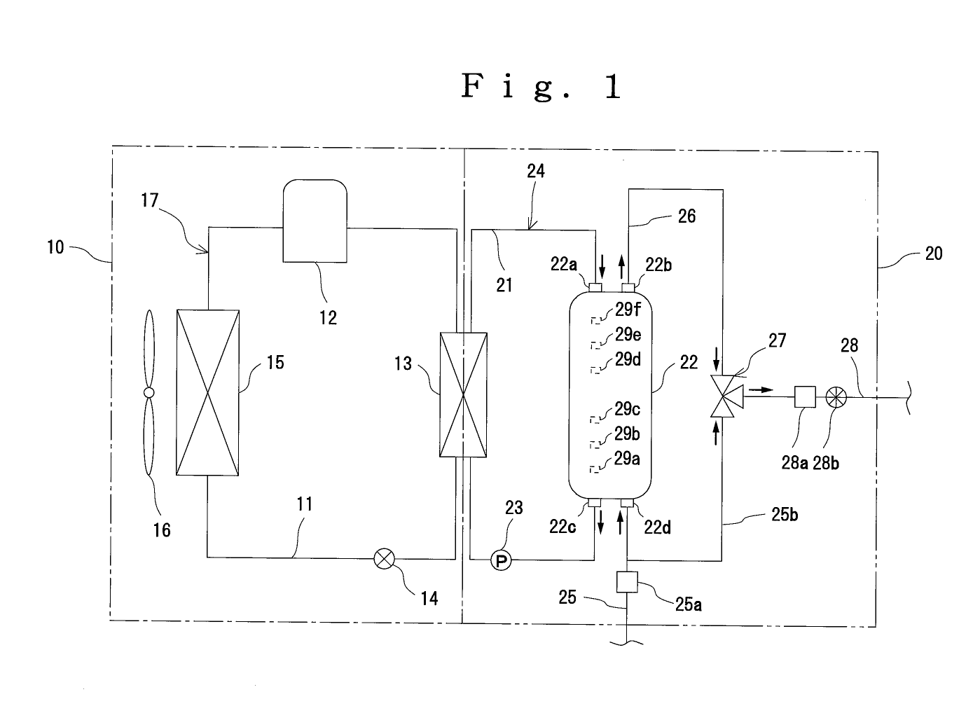

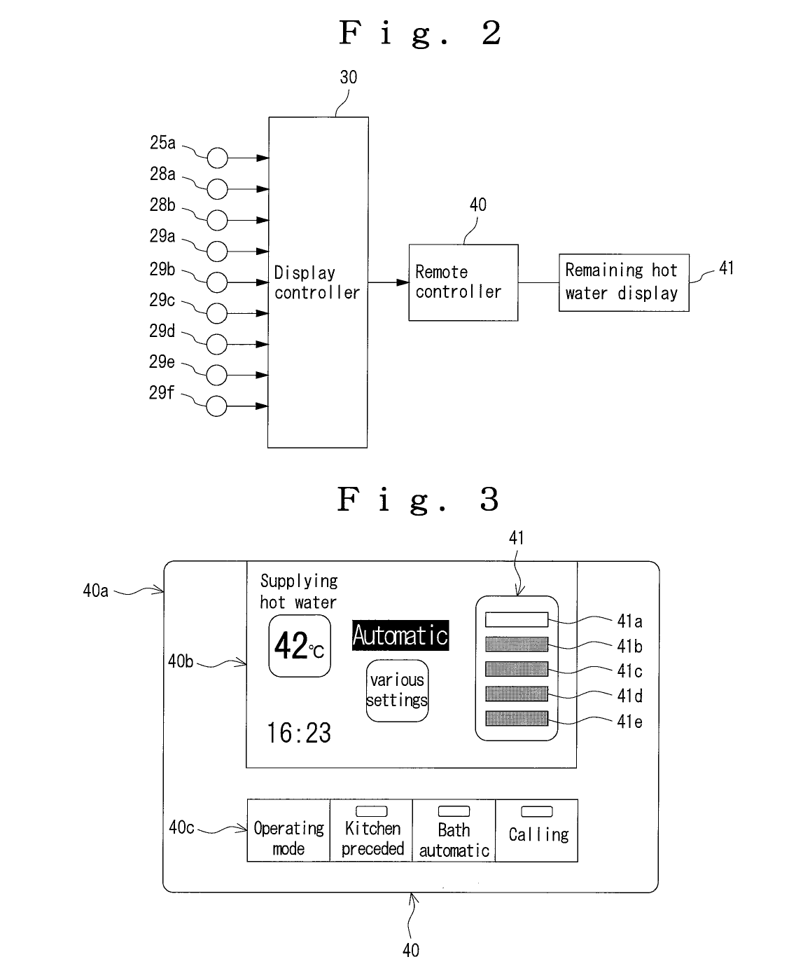

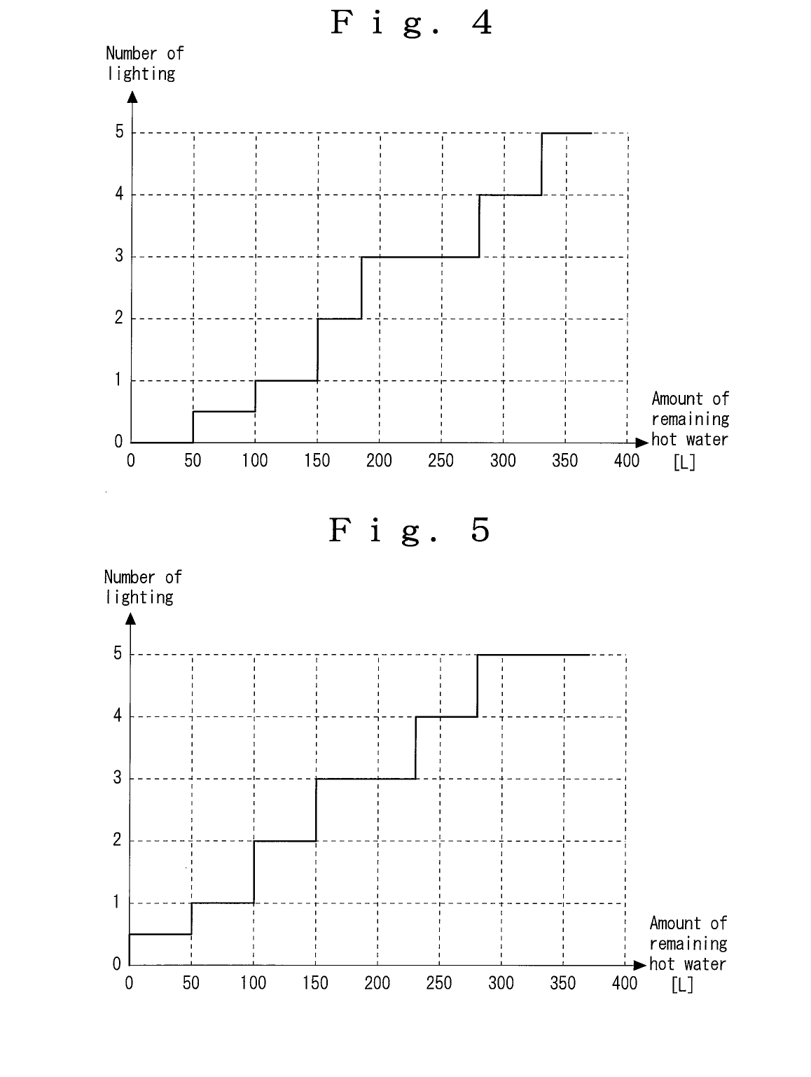

FIGS. 1 to 4 show the first embodiment of the present invention. FIG. 1 is an outline composition view of a heat pump type hot water supply apparatus, FIG. 2 is a block diagram showing a control system composition of the heat pump type hot water supply apparatus shown in FIG. 1, FIG. 3 is an external front view of a remote controller shown in FIG. 2, FIG. 4 is a diagram showing a relationship between remaining hot water in a hot water storage tank and a remaining hot water display.

First, the composition of the heat pump type hot water supply apparatus in accordance with one embodiment of the present invention is explained with reference to FIG. 1.

The heat pump type hot water supply apparatus includes a heat pump unit 10 and a hot water storage unit 20. The heat pump unit has a refrigerant circuit 17 composed by sequentially connecting a compressor 12, a water heat exchanger 13, a pressure reducing valve 14, and a heat exchanger 15 via refrigerant pipes 11. Refrigerant, such as CO₂, is sealed in the refrigerant circuit 17.

The compressor 12 has a motor (not shown) as a driving source. The compressor 12 has a generally known composition so that the revolution thereof is variably controlled. The compressor 12 applies pressure to the refrigerant and circulates it in the refrigerant circuit 17.

The water heat exchanger 13 conducts heat-exchange between a high temperature and pressured refrigerant which is discharged from the compressor 12 and flows in the refrigerant pipe 11 and water flows in a circulation pipe 21 which is described later. By this, the water heat exchanger 13 functions as a condenser so that water flowing in the later-described circulation pipe 21 is heated.

The pressure reducing valve 14 is a commonly known motor-operated valve. The pressure reducing valve 14 depressurizes the refrigerant from which heat is absorbed by the water heat exchanger 13 and changes the said refrigerant into a low-temperature and pressure one.

The heat exchanger 15 conducts heat-exchange between the refrigerant flowing in from the pressure reducing valve 14 and outside air supplied by a fan 16. The refrigerant which went through the heat exchanger 15 flows into the compressor 12 via the refrigerant pipe 11. By this, the heat exchanger 15 functions as an evaporator so the refrigerant is heated.

The hot water storage unit 20 has a circulation circuit 24 composed by sequentially connecting a hot water storage tank 22, a circulation pump 23, and the above mentioned water heat exchanger 13 via the circulation pipe 21. Also, the hot water storage unit 20 has a water supply pipe 25, a water temperature sensor 25a, a branch pipe 25b, hot water outlet pipe 26, a mixing valve 27, a hot water supply pipe 28, a hot water temperature sensor 28a, a flowmeter 28b, and a stored hot water thermometers 29a-29f.

The hot water storage tank 22 has a circulation inlet 22a and a hot water outlet 22b in the upper part thereof, and the hot water storage tank 22 has a circulation outlet 22c and a water inlet 22d in the lower part thereof. From the outside water source (not shown), water is supplied to the hot water storage tank 22 via the water supply pipe 25 and the water inlet 22d.

The circulation pump 23 applies pressure to the water flowing out from the circulation outlet 22c, circulates the pressured water in the circulation circuit 24, and flows the pressured water into the hot water tank 22 through the circulation inlet 22a. By this, water flowing out of the lower part of the hot water storage tank 22 is heated by the water heat exchanger 13 of the heat pump unit 10, and the hot water at the predetermined temperature such as higher than 60° C. (hereinafter referred as hot water), is supplied to the hot water storage tank 22 from the upper part thereof.

A mixing valve 27 comprises a publicly known three way valve. The mixing valve 27 mixes hot water flowing in from the hot water outlet 22b via the hot water outlet pipe 26 together with water supplied through the branch pipe 25b which diverged from the water supply pipe 25. The mixing valve 27 supplies hot water at a temperature set up by users to the outside through the hot water supply pipe 28.

The water temperature sensor 25a provided to the water supply pipe 25 detects the temperature of water supplied to the hot water storage tank 22 and the mixing valve 27 from the water source (not shown). The hot water temperature sensor 28a and the flowmeter 28b provided to the hot water supply pipe 28 detect the temperature and flow rate of hot water supplied from the mixing valve 27 to the outside, respectively.

The stored hot water thermometers 29a-29f is placed in the hot water storage tank 22 so as to be located at different positions in the up-and-down direction mutually. The stored hot water thermometers 29a-29f respectively detects temperatures of hot water or water at their installed positions in the hot water storage tank 22. By this, it becomes possible to detect the amount of hot water or water in the hot water storage tank 22 by the installed positions of the stored hot water thermometers 29a-29f detecting a predetermined temperature.

In this embodiment, the capacity of the hot water storage tank 22 is 370 liters. Also, the stored hot water thermometers 29a-29f are installed at positions corresponding to the amount of remaining hot water of 330 liters, 280 liters, 230 liters, 150 liters, 100 liters, and 50 liters in the hot water storage tank 22, respectively.

Next, a control system composition for displaying the amount of remaining hot water in the hot water storage tank 22 is explained with reference to FIGS. 2 and 3.

As is shown in FIG. 2, a display controller 30 makes a remote controller 40 display the amount of hot water in the hot water storage tank 22 by a plurality of levels which are described below. The display controller 30 is comprised of a commonly known computer which has a memory such as RAM, ROM, and etc. and a CPU. Also, the display controller 30 is connected to the above referenced water temperature sensor 25a, hot water temperature sensor 28a, flowmeter 28b, stored hot water thermometers 29a-29f and remote controller 40.

The display controller 30 outputs an operate signal to the remote controller 40 in accordance a program stored in the memory of the display controller 30 itself, the water temperature sensor 25a, the hot water temperature sensor 28a, flowmater 28b, and detected signals of the stored hot water thermometers 29a-29f.

The remote controller 40 is for users to operate various settings of the heat pump type hot water supply apparatus. As is shown in FIG. 3, a display portion 40b for displaying a predetermined information and an operation portion 40c having a plurality of buttons are provided on a surface panel 40a of the remote controller 40. The display portion 40b has a remaining hot water display 41 showing the amount of remaining hot water in the hot water storage tank 22. And the remaining hot water display 41 has a plurality of scales 41a-41e.

The remote controller 40 displays the amount of remaining hot water in the hot water storage tank 22 by letting the scales 41a-41e of the remaining hot water display 41 light, extinguish, or flicker in accordance with a control signal from the display controller 30. In FIG. 2, the scale 41a of the remaining hot water display 41 is extinguished and the scales 41b-41e of the remaining hot water display 41 are lighted.

Next, a relationship between the amount of hot water in the hot water storage tank 22 and the remaining hot water display is explained with reference to FIG. 4.

After the heat pump unit 10 heats water in the hot water storage tank 22 and the hot water storage tank 22 is filled with hot water, when the hot water is supplied to the outside from the hot water storage tank 22 in accordance with demands from the users, and if the stored hot water thermometers 29a-29f respectively detects temperatures higher than 60° C. as is shown in FIG. 4, the amount of hot water in the hot water storage tank 22 is 330 liters or more, thus, the display controller 30 turns on all of the scales 41a-41e of the remaining hot water display 41. When the stored hot water thermometers 29b-29f respectively detects temperatures higher than 60° C., the amount of hot water in the hot water storage tank 22 is more than 280 liters and less than 330 liters, hence, the display controller 30 turns off the scale 41a of the hot water display 41. When the stored hot water thermometers 29c-29e respectively detects temperatures higher than 60° C., the amount of the hot water in the hot water tank 22 is more than 230 liters and less than 280 liters, therefore, the display controller 30 extinguishes the scale 41b of the remaining hot water display 41.

When the stored hot water thermometers 29d-29f respectively detects temperatures higher than 60° C., the amount of hot water in the hot water storage tank 22 is more than 150 liters and less than 230 liters. If the display controller 30 turns off the scale 41c of the remaining hot water display 41, only 2 scales 41d, 41e out of 5 scales 41a-41e will be lightened. By this, it gives an impression to the users that the amount of remaining hot water in the hot water storage tank 22 is less than half the capacity of the tank, even if the actual amount of hot water in the hot water storage tank 22 is 229 liters.

The display controller 30 calculates a hot water ratio h when the scales 41c-41e of the remaining hot water display 41 is lightened and when the stored hot water thermometers 29d-29f respectively detects temperatures higher than 60° C. (when the stored hot water thermometer 29c detects temperature lower than 60° C.). The hot water ratio h is calculated in accordance with detected signals of a water supply temperature Ts from the water temperature sensor 25a, a hot water supply temperature Tt from the hot water temperature sensor 28a, and a stored hot water temperature Tc from the stored hot water thermometer 29f and by using the formula (1) below.

h=(Tt−Ts)/(Tc−Ts) (1)

Also, the display controller 30 calculates, in advance, a hot water supply amount R which was supplied to the outside after the hot water storage tank 22 is filled with hot water based on a detected flow rate of the flowmeter 28b. And, the display controller 30 calculates a remaining hot water amount Z by using the formula (2) below.

Z=370−R×h (2)

When the calculated remaining hot water amount Z is more than 185 liters and less than 230 liters, the display controller 30 keeps the 3 scales 41c-41e of the remaining hot water display 41 lighting. As such, a change amount of hot water which changes the level lighting the 3 scales 41c-41e of the remaining hot water display 41 to the next level thereof is larger than a change amount of hot water which changes the other levels, such as the level lighting the 4 scales 41b-41e of the remaining hot water display 41 to the next level thereof. In other word, when an amount of hot water which changes the remaining hot water display 41 from the level lighting the 4 scales 41b-41e of the remaining hot water display 41 to the next level thereof is supplied to the outside from the hot water storage tank 22, the display controller keeps the same level lighting the 3 scales 41c-41e of the remaining hot water display 41 and does not change the level to the next level thereof.

When the calculated remaining hot water amount Z becomes less than 185 liters, the display controller 30 extinguishes the scales 41a-41c of the remaining hot water display 41. As such, the display controller 30 changes the level lighting the 3 scales 41c-41e of the remaining hot water display 41 to the next level thereof according to the actual amount of hot water in the hot water storage tank 22.

When the stored hot water thermometers 29e and 29f respectively detects temperatures higher than 60° C., the amount of hot water in the hot water storage tank 22 is more than 100 liters and less than 150 liters, therefore, the display controller 30 extinguishes the scale 41d of the remaining hot water display 41. When the stored hot water thermometer 29f detects temperature higher than 60° C., the amount of hot water in the hot water storage tank 22 is more than 50 liters and less than 100 liters, hence, the display controller 30 makes the scale 41e of the remaining hot water display 41 flicker. When the stored hot water thermometer 29f detects temperature lower than 60° C., there is no hot water or less than 50 liters of hot water in the hot water storage tank 22, therefore, the display controller 30 extinguishes the scale 41e of the remaining hot water display 41. In the FIG. 4, the state of the scale 41e flickering is shown as the lighting number of 0.5.

In this embodiment, when hot water is supplied to the outside from the hot water storage tank 22, the change amount of hot water which changes the remaining hot water display 41 from the predetermined level to the next level thereof is larger than the change amount of hot water which changes the remaining hot water display 41 from the other levels to the next level thereof. On the other hand, when the heat pump unit 10 heats water in the hot water storage tank 22 and the hot water storage tank 22 is being filled up with hot water, the change amount of hot water which changes the remaining hot water display 41 from the predetermined level to the next level thereof can also be larger than the change amount of hot water which changes the remaining hot water display 41 from the other levels to the next level thereof. However, it is preferable to make the change amount of hot water larger only when hot water is supplied to outside from the hot water storage tank 22. By this, when the hot water storage tank 22 is being filled up with hot water, the change amount of hot water which changes the remaining hot water display 41 from the predetermined level to the next level thereof does not become larger than the change amount of hot water which changes the remaining hot water display 41 from the other levels to the next level thereof. Hence, when the change amount of hot water which changes the remaining hot water display 41 from the other levels to the next level thereof is supplied to the hot water storage tank 22 from the outside, the remaining hot water display 41 can be changed from the predetermined level to the next level thereof.

Also, in this embodiment, the remaining hot water amount Z is calculated when the display controller 30 turns on the scales 41c-41e of the remaining hot water display 41, and when the stored hot water thermometer 29c detects temperature lower than 60° C. On the other hand, the remaining hot water amount Z can be calculated at any times regardless of the display status of the remaining hot water display 41 or the temperature detected by the stored hot water thermometers 29a-29f.

In addition, in this embodiment, when the calculated remaining hot water amount Z becomes less than the predetermined amount, the remaining hot water display 41 will be changed from the predetermined level to the next level thereof. On the other hand, for example, when a predetermined time passes from a predetermined level, it is also possible to change the remaining hot water display 41 from the predetermined level to the next level thereof, so that the change amount of hot water which changes the remaining hot water display 41 from the predetermined level to the next level thereof becomes larger than the change amount of hot water which changes the remaining hot water display 41 from the other levels to the next level thereof.

The remaining hot water display 41 with a plurality of scales 41a-41e is nothing but an example. As long as remaining hot water in the hot water storage tank 22 is displayed step by step, other ways are acceptable, such as by frequency of having bath or shower, duration of hot water supply time in kitchens, liters (for example, for every 10 liters), and etc.

As such, in this embodiment, the heat pump type hot water supply apparatus, the change amount of hot water which changes the level lighting the 3 scales 41c-41e of the remaining hot water display 41 to the next level thereof is larger than a change amount of hot water which changes the other levels, for example, the level lighting the 4 scales 41b-41e of the remaining hot water display 41 to the next level thereof. By this, even when the amount of hot water which changes the remaining hot water display 41 from the level lighting the 4 scales 41b-41e of the remaining hot water display 41 to the next level thereof is supplied to the outside from the hot water storage tank 22, the level lighting the 3 scales 41c-41e of the remaining hot water display 41 does not change to the next level thereof. Hence, it becomes possible to let the amount of remaining hot water in the hot water storage tank 22 at the predetermined level display larger than the amount of remaining hot water at the other levels. Also, by setting an appropriate amount of hot water which changes the display from the predetermined level to the next level thereof, it becomes possible to display the amount of remaining hot water which is not so different from the actual amount of hot water in the hot water storage tank 22. Accordingly, it becomes capable of preventing users from being unnecessarily anxious about shortage of hot water.

Also, the change amount of hot water which changes the remaining hot water display 41 from the predetermined level to the next level thereof becomes larger than the change amount of hot water which changes the remaining hot water display 41 from the other levels to the next level thereof only when hot water is supplied to the outside form the hot water storage tank 22. By this, when hot water is supplied to the hot water storage tank 22, the change amount of hot water which changes the remaining hot water display 41 from the predetermined level to the next level thereof does not become larger than the change amount of hot water which changes the remaining hot water display 41 from the other levels to the next level thereof. Thus, when the change amount of hot water which changes the remaining hot water display 41 from the other levels to the next level thereof is supplied to the hot water storage tank 22 from the outside, the remaining hot water display 41 can be changed from the predetermined level to the next level thereof. Accordingly, it can prevent users from becoming anxious that the amount of hot water in the hot water storage tank 22 is not increasing when water in the hot water storage tank 22 is heated by the heat pump unit 10.

Moreover, when the calculated remaining hot water amount Z becomes less than 185 liters, the display controller 30 turns off the scale 41c of the remaining hot water display 41. More specifically, according to the actual amount of hot water in the hot water storage tank 22, the remaining hot water display 41 will be changed from the level lighting 3 scales 41c-41e to the next level thereof. By this, it becomes possible to display the amount of remaining hot water which is not so different from the actual amount of hot water in the hot water storage tank 22 and to prevent users from being unnecessarily anxious about shortage of hot water more effectively.

Next, the second embodiment of the present invention is explained in accordance with reference to FIG. 5.

FIG. 5 is a diagram showing a relationship between the remaining hot water in the hot water storage tank 22 and the remaining hot water display.

In the second embodiment, the remaining hot water display 41 is changed from the predetermined level to the next level thereof after a predetermined stored hot water thermometer detects the temperature lower than a predetermined temperature and before a stored hot water thermometer right under the said predetermined stored hot water thermometer detects the temperature lower than the predetermined temperature. This is different from the first embodiment of this invention. The compositions which are the same to the ones in the previously explained first embodiment are assigned the same symbols and not explained.

As is shown in FIG. 5, if the stored hot water thermometers 29a-29f respectively detects temperatures higher than 60° C. and the display controller 30 turns on all of the scales 41a-41e of the remaining hot water display 41, when the stored hot water thermometer 29a detects temperature lower than 60° C., the display controller 30 does not extinguish the scale 41a of the remaining hot water display 41 promptly, but keeps the scales 41a-41e lighting. After that, before the stored hot water thermometer 29b detects temperature lower than 60° C., more specifically, when the stored hot water thermometer 29b detects temperature at 60° C. (when the amount of hot water in the hot water storage tank 22 is 280 liters), the display controller 30 extinguishes the scale 41a of the remaining hot water display 41. If the stored hot water thermometers 29c-29f respectively detects temperatures higher than 60° C. and the display controller 30 turns on the scales 41b-41e of the remaining hot water display 41, when the stored hot water thermometer 29c detects 60° C. (when the amount of hot water in the hot water storage tank 22 is 230 liters), the display controller 30 extinguishes the scale 41b of the remaining hot water display 41. If the stored hot water thermometers 29d-29f respectively detects the temperatures higher than 60° C. and the display controller 30 turns on the scales 41c-41e of the remaining hot water display 41, when the stored hot water thermometer 29d detects 60° C. (when the amount of hot water in the hot water storage tank 22 is 150 liters), the display controller 30 extinguishes the scale 41c of the remaining hot water display 41. If the stored hot water thermometers 29e and 29f respectively detects temperatures higher than 60° C. and the display controller 30 turns on the scales 41d and 41e of the remaining hot water display 41, when the stored hot water thermometer 29e detects 60° C. (when the amount of hot water in the hot water storage tank 22 is 100 liters), the display controller 30 extinguishes the scale 41d of the remaining hot water display 41. If the stored hot water thermometer 29f detects temperature higher than 60° C. and the display controller 30 lights the scale 41e of the remaining hot water display 41, when the stored hot water thermometer 29f detects 60° C. (when the amount of remaining hot water in the hot water storage tank 22 is 50 liters), the display controller 30 let the scale 41e of the remaining hot water display 41 flicker. As such, after the stored hot water thermometer 29a detects temperatures lower than 60° C., and before the stored hot water thermometer 29b right under the said stored hot water thermometer 29a detects temperature lower than 60° C., the display controller 30 extinguishes the scale 41a of the remaining hot water display 41, and changes the level lighting all the 5 scales 41a-41e of the remaining hot water display 41 to the next level thereof. By this, the change amount of hot water which changes the level lighting the 5 scales 41a-41e of the remaining hot water display 41 to the next level thereof is larger than the other level, for example, the level lighting the 4 scales 41b-41e of the remaining hot water display 41 to the next level thereof.

As such, by this embodiment, the heat pump type hot water supply apparatus, after the stored hot water thermometer 29a detects temperature lower than 60° C., and before the stored hot water thermometer 29b right under the stored hot water thermometer 29a detects temperature lower than 60° C., the display controller 30 extinguishes the scale 41a of the remaining hot water display 41. Thus, the level lighting the 5 scales 41a-41e of the remaining hot water display 41 will be changed to the next level thereof. By this, the change amount of hot water which changes the level lighting 5 scales 41a-41e of the remaining hot water display 41 to the next level thereof is larger than the other levels thereof (for example, the change amount of hot water which changes the level lighting 4 scales 41b-41e to the next level thereof), so it is possible to achieve the same effect of the first embodiment.

The preferred embodiments described in this specification are illustrative and not restrictive. The scope of invention is given by the appended claims, and all changes and modifications included in the meaning of claims are embraced in the present invention.

1. A heat pump type hot water supply apparatus, comprising:
a hot water storage tank,
a remaining hot water display for displaying an amount of remaining hot water in the hot water storage tank by a plurality of levels,
a display control means for changing the remaining hot water display according to the amount of remaining hot water in the hot water storage tank, wherein
a change amount of hot water which changes the remaining hot water display from a predetermined level to the next level thereof by the display control means is larger than a change amount of the hot water which changes the remaining hot water display from the other levels to the next level thereof by the display control means.

2. The heat pump type hot water supply apparatus according to claim 1, wherein
the display control means operates when remaining hot water in the hot water storage tank is being supplied to the outside.

3. The heat pump type hot water supply apparatus according to claim 2, further comprising:
a remaining hot water amount calculating means for calculating the amount of remaining hot water in the hot water storage tank according to an amount of the hot water supplied to the outside from the hot water storage tank, wherein the display control means changes the remaining hot water display from said predetermined level to the next level thereof when a calculated amount of remaining hot water becomes less than a predetermined amount.

4. The heat pump type hot water supply apparatus according to claim 2, further comprising:
a plurality of temperature detecting means placed in the hot water storage tank so as to be located at different positions in the up-and-down direction mutually, the temperature detecting means for detecting the temperature of the hot water or water in the hot water storage tank respectively, wherein
the display control means changes the remaining hot water display from said predetermined level to the next level thereof after a predetermined temperature detecting means detects a temperature less than a predetermined temperature and before the temperature detecting means right under the said predetermined temperature detecting means detects the said temperature less than the predetermined temperature.

5. The heat pump type hot water supply apparatus according to claim 3, further comprising:
a plurality of temperature detecting means placed in the hot water storage tank so as to be located at different positions in the up-and-down direction mutually, the temperature detecting means for detecting the temperature of the hot water or water in the hot water storage tank respectively, wherein
the display control means changes the remaining hot water display from said predetermined level to the next level thereof after a predetermined temperature detecting means detects a temperature less than a predetermined temperature and before the temperature detecting means right under the said predetermined temperature detecting means detects the said temperature less than the predetermined temperature.
